(19) United States
(12) Patent Application Publication
(10) Pub. No.: US 2003/0190149 A1
(43) Pub. Date: Oct. 9, 2003

(54) Server-based programming of appliances via an information network

(76) Inventors: Chieh-Chung Chang, Monmouth Junction, NJ (US); Ibrahim Kamel, Monmouth Junction, NJ (US)

Correspondence Address: RATNERPRESTIA, P O BOX 980, VALLEY FORGE, PA, 19482-0980, US

(21) Appl. No.: 10/102,925

(22) Filed: Mar. 21, 2002

(51) Int. Cl. H04N 5/76; G06F 3/00; H04N 5/91; G06F 13/00

(52) U.S. Cl. 386/83; 725/58

(57) ABSTRACT

The invention includes a system and method of programming a recording device to record at least one broadcast program. The method receives at a server, through a communications network, a request to program the recording device. The server customizes a page of programming information, including an identification of the one broadcast program. The customizing includes attaching a hyper link to the identified broadcast program and embedding an instruction to the recording device in the hyper link. The server transmits the customized page of programming information for user selection of the identified broadcast program through the hyper link. The request to program the recording device is transmitted through the communications network from a device, such as a cellular telephone, a personal computer or a personal digital assistant.

### FIELD OF THE INVENTION

The present invention relates, in general, to programming and monitoring of appliances. More specifically, the present invention relates to a method and system for programming and monitoring of a recording device through a computer network, such as the Internet.

### BACKGROUND OF THE INVENTION

Scott (U.S. Pat. No., 4,625,080, issued Nov. 25, 1986) discloses a method for remotely programming a video cassette recorder (VCR). A user at a remote location holds a hand held device and enters programming instructions though a keypad. The instructions are encoded and transmitted via telephone lines to a receiver which interfaces with the VCR. The instructions include the channel to be taped and the time and date the taping is to take place.

The method disclosed by Scott requires user interaction. The user must enter programming instructions into his hand-held device and establish telephone contact with the receiver located adjacent to the VCR. Once the user has established telephone contact, he must place a mouthpiece of the telephone in close proximity to his hand held device and actuate transmission. Programming instructions stored inside the hand held device are then transmitted through a speaker, along the telephone lines, to a second telephone and finally to the receiver where the instructions are stored. The receiver interfaces with the VCR and causes it to respond to the programming instructions. The user does not know whether the receiver is successful in controlling the VCR.

Hashimoto (U.S. Pat. No. 5,420,913, issued May 30, 1995) discloses a remotely controlled device for making recording reservations on a VCR using a remote push button telephone to enter recording reservation codes, such as PlusCodes. The user may also listen to the audio portion of the television program as it is being recorded. The method disclosed by Hashimoto requires user interaction. The user first establishes telephone contact with the device and, using the push button telephone, programs the VCR to record a specific program.

An appliance generally requires a processor and a memory for accepting user programming instructions and executing the instructions. The processor and memory tend to increase the cost of the appliance. In addition, software programs for operation of the appliance are typically embedded in the appliance at the time of manufacture and are difficult, if not impossible, to upgrade.

There is a need for an improved method for remotely programming and monitoring a recording device without requiring user interaction. There is also a need for providing a user an easy and simple approach to remotely programming the recording device. This invention addresses those needs.

### SUMMARY OF THE INVENTION

To meet this and other needs, and in view of its purposes, the present invention includes a method of programming a recording device to record at least one broadcast program. The method receives at a server, through a communications network, a request to program the recording device. The server customizes a page of programming information, including an identification of the one broadcast program. The customizing includes attaching a hyper link to the identified broadcast program and embedding an instruction to the recording device in the hyper link. The server transmits the customized page of programming information for user selection of the identified broadcast program through the hyper link. The request to program the recording device is transmitted through the communications network from a device, such as a cellular telephone, a personal computer or a personal digital assistant.

The method may include first transmitting from the server to the recording device the customized page and then transmitting from the server to the recording device the embedded instruction, after the user selects the hyper link. The method may also include embedding recording preferences of the user and embedding an identification of the recording device, such as an address and a manufacturer model number.

In another embodiment, the method may include transmitting instructions to an appliance for recording broadcasting programs on a video recorder, where the video recorder is included in the appliance and the instructions include recording at least one program scheduled for broadcasting. The server may access an EPG to determine a time corresponding to the scheduled broadcast of the program, and then may reformat the received instructions to include the time corresponding to the scheduled broadcast. The server may then transmit to the appliance the reformatted instructions, at a predetermined time prior to the time corresponding to the scheduled broadcast.

The invention also includes a system for programming a video recorder. The system includes a server connected to a network; a database accessible by the server including electronic program guide (EPG) information; a video recorder coupled via an appliance to the network; and a device accessible to the network, where the device accesses the network and requests the server to program the video recorder to record a scheduled broadcast. The server, in response to the request, accesses the database to determine a time corresponding to the scheduled broadcast. The server then accesses the network and downloads to the appliance programming data for the video recorder.

The device may include a cellular telephone, a personal computer, or a personal digital assistant. The video recorder may be coupled to the appliance via an IR receiver or a consumer bus. The database may include a look-up table listing the time corresponding to the scheduled broadcasting of the program, and the server may update the look-up table using electronic program guide (EPG) information. The EPG information may be stored at information sites accessible by the server via the communications network.

It is understood that the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is an overview of a system for server-based programming of an appliance according to an embodiment of the present invention;

FIG. 2 is an exemplary embodiment of an Internet-ready appliance connected to a television and a VCR;

FIG. 3 is another exemplary embodiment of an Internet-ready appliance connected to a recording device;

FIG. 4 is a basic workflow diagram illustrating steps involved in a typical operation executed via interfacing software between a server and a remote user according to an embodiment of the invention;

FIG. 5 is a basic workflow diagram illustrating steps involved in a typical operation executed via interfacing software between a server and an Internet-ready appliance according to an embodiment of the invention;

FIG. 6 is yet another exemplary embodiment of an Internet-ready appliance connected to a device for controlling lighting conditions at a remote location;

FIG. 7 is still another exemplary embodiment of an Internet-ready appliance connected to a device for controlling air-conditioners at a remote location;

FIG. 8 is yet a further embodiment of an Internet-ready appliance connected to a newly installed device;

FIG. 9 is a schematic illustration of an exemplary one-click programming system according to an embodiment of the invention; and

FIG. 10 is a basic workflow diagram illustrating steps of one-click programming in the system of FIG. 9.

### DETAILED DESCRIPTION OF THE INVENTION

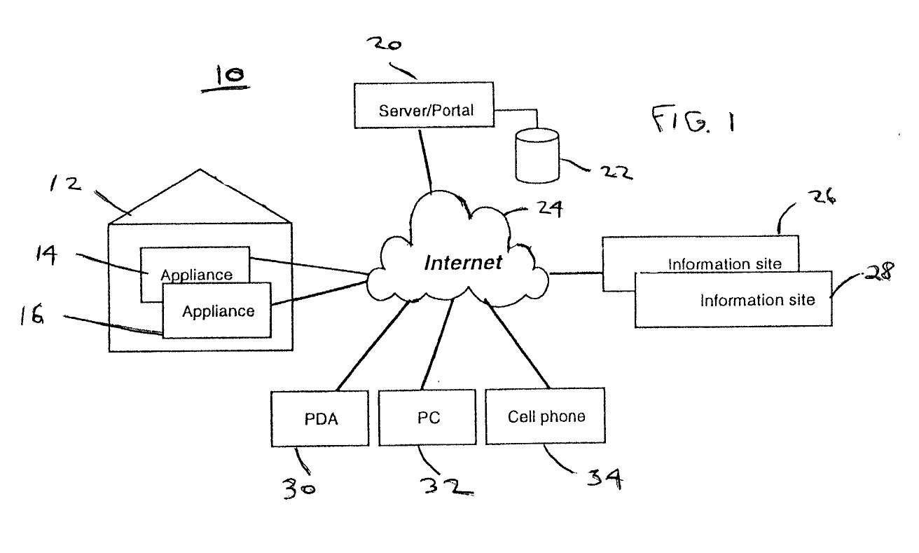

FIG. 1 is an overview of a system for server-based programming of an appliance, generally designated by numeral 10. In the embodiment shown, system 10 includes server 20 communicatively coupled by way of global communications network 24 (e.g., the Internet) to appliances 14 and 16 located in house 12. Appliance 14 or 16 may be any appliance, such as a set-top box, that is accessible via the Internet. By using a device, such as personal digital assistant (PDA) 30, personal computer (PC) 32 or cellular telephone 34 to access Internet 24, a user may remotely program appliances 14 and 16 through server 20.

The server may store appliance configurations and user programming instructions in database (repository) 22. The server may also collect data from information sites 26 and 28. With programming instructions from the user, the server may access the appliance at a later time and program the appliance without requiring real time user access.

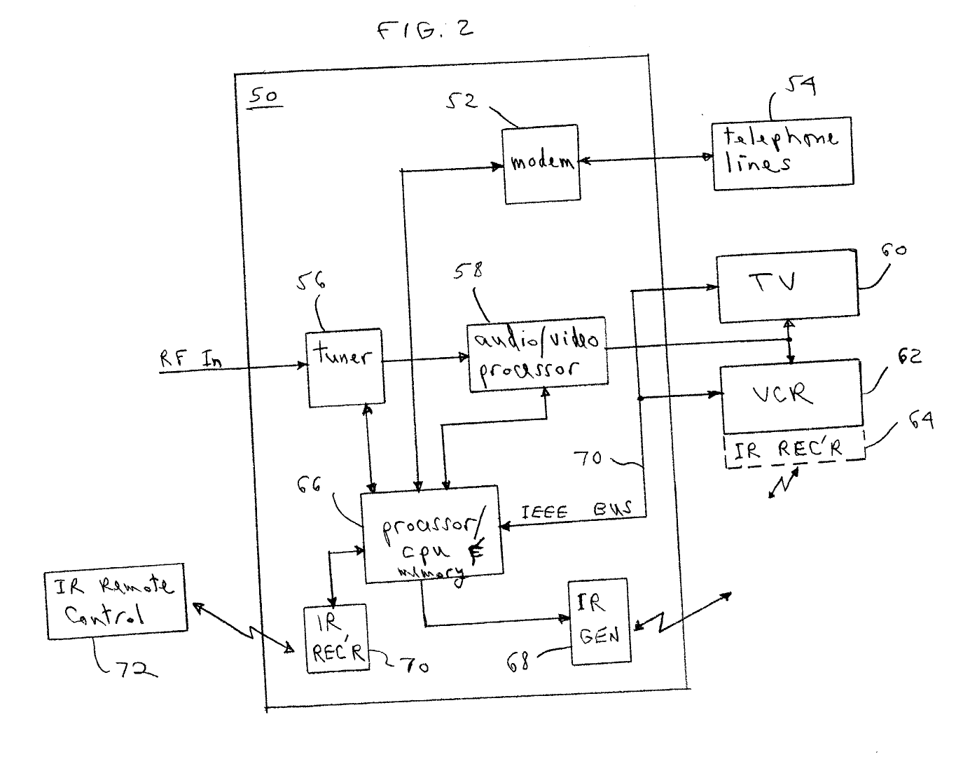

An exemplary embodiment of an information appliance is shown in FIG. 2 and is generally designated by the numeral 50. Exemplary appliance 50 includes modem 52 connected or attached to telephone lines 54 for accessing the Internet via an Internet service provider (ISP). Different types of data, including initialization and programming data, may be exchanged between appliance 50 and server 20 (FIG. 1).

The data exchanged may include user and appliance identification and user preferences for downloading programming data from the server. The data may be formatted according to an application layer protocol having frame formats for telephone functions. These may include communications protocol hierarchy with Application Program Interface (API). Point-to-Point Protocol (PPP), and High-level Data Link Control (HDLC) layers for telephony applications.

It will be appreciated that although appliance 50 is shown connected to telephone lines 54, it may be connected to a digital subscriber line (DSL), a twisted-pair cable, an integrated service digital network (ISDN) link, or any other link, wired or wireless, that supports data communications with a remote server. For example, the data communications may be through packet switched communications, including Internet Protocol (IP)/Transmission Control Protocol (TCP) communications using an Ethernet.

Appliance 50 may include output devices, such as television 60 for displaying video information and VCR 62 for recording video signals. VCR 62 may include IR receiver 64 for receiving control commands from a user remote control (not shown). Appliance 50 also includes tuner 56 for selecting a specific channel to tune in an RF signal received from a remote ground broadcasting station, a satellite or coaxial cable. Processing of the selected signal is performed by audio and video processor 58 to produce digital television signals or analog television signals, which are then output to TV 60 and VCR 62. Processor 58 may encode the audio and video signals in a unique format for presentation and listening (e.g., an NTSC or ACTV format for television).

The operation of appliance 50 is controlled by processor/CPU 66, which may be a general purpose data processor or a special purpose data processor, such as an application specific integrated circuit (ASIC). Processor 66 may control tuner 56 for selection of a broadcast signal and modem 52 for Internet access via telephone lines 54. Processor 66 may also control TV 60 and VCR 62 by way of digital communications bus 70, which may be an IEEE 1394 bus. Furthermore, processor 66 may be configured, for example, via a cable modem (not shown), to connect to the Internet via the RF signal applied to tuner 56.

Alternatively, processor 66 may control VCR 62 by way of IR generator 68. The exemplary IR generator provides a high powered IR signal to remotely control VCR 62 without special connections. It has been found that a high-powered IR generator may be used to blanket or saturate a room with the desired control signal and be picked up by IR receiver 64 to control the VCR operation. Such an IR generator is generally known as an IR blaster.

In the exemplary embodiment of FIG. 1, user input may be supplied through IR remote control 72 which sends an infrared signal to internal IR receiver 70. The internal IR receiver decodes received commands and sends them to processor 66.

In one embodiment of the invention, processor 66 may assemble data received from telephone lines 54 to control recording of audio and video signals received from television broadcasting stations. Data received from telephone lines 54 may be downloaded from server 20 (FIG. 1) and stored in a memory (not shown) accessible by processor 66. The data may include names and titles of viewing events, corresponding channel numbers and news, brief descriptions of the programs, and program initiation and termination information. Processor 66, in response to the received data, may control signal selection through tuner 56 and VCR program recording through digital communications bus 70 or IR generator 68.

It will be appreciated that appliance 50 may be operated by a user, through IR remote control 72, to program recording of VCR 62. In the exemplary embodiment of the invention, however, server 20 may download programming instructions through telephone lines 54 to program recording events in VCR 62. Accordingly, processor 66 may process VCR programming instructions from IR receiver 70 or from modem 52.

It will also be appreciated that downloading of programming instructions may be performed by server 20 in a single interval of time. In this downloading mode, the entire data is transmitted through the telephone lines and accepted for storage in a look-up table by processor 66. Processor 66 then sequences through the look-up table and controls recording events of VCR 62.

Alternatively, server 20 may download programming instructions via modem 52 at different intervals of time. For example, assume that the user in his automobile, utilizing cellular phone 34, instructs sever 20 to record every broadcast of OPRAH for the next week. Server 20, having the latest electronic programming guide (EPG) information, may determine that OPRAH is scheduled for broadcast on Tuesday at 9:30 a.m. and 5:00 p.m. A few minutes before 9:30 a.m. on Tuesday (for example, 9:28 a.m.), server 20 may attempt an on-line connection with processor 66 by way of telephone lines 54. After on-line connection, server 20 may command processor 66 to select the appropriate channel on tuner 56 and activate the record function of VCR 62 at 9:30 a.m. for the next hour. Similarly, a few minutes before 5:00 p.m. on Tuesday, server 20 may again initiate an on-line connection and command processor 66 to tune in OPRAH and activate the record function of VCR 62. In this downloading mode, processor 66 follows programming instructions provided by server 20 and does not require access to a stored look-up table. Appliance 50 may thus require less storage capacity, because programming instructions may be stored only in database 22 of server 20.

In addition, if programming schedules change, the user selection criteria may be applied to an updated schedule, as determined by server 20. The VCR may be activated by server 20 based upon new scheduled times. In other words, VCR activation may be based on a selected program, or a series of programs, regardless of when this program is broadcast. In the above example, if OPRAH is scheduled to be transmitted in a new time slot, the new time slot need not be known by processor 66. Server 20 may activate recording of OPRAH in the new time slot, based on updated EPG information stored in database 22.

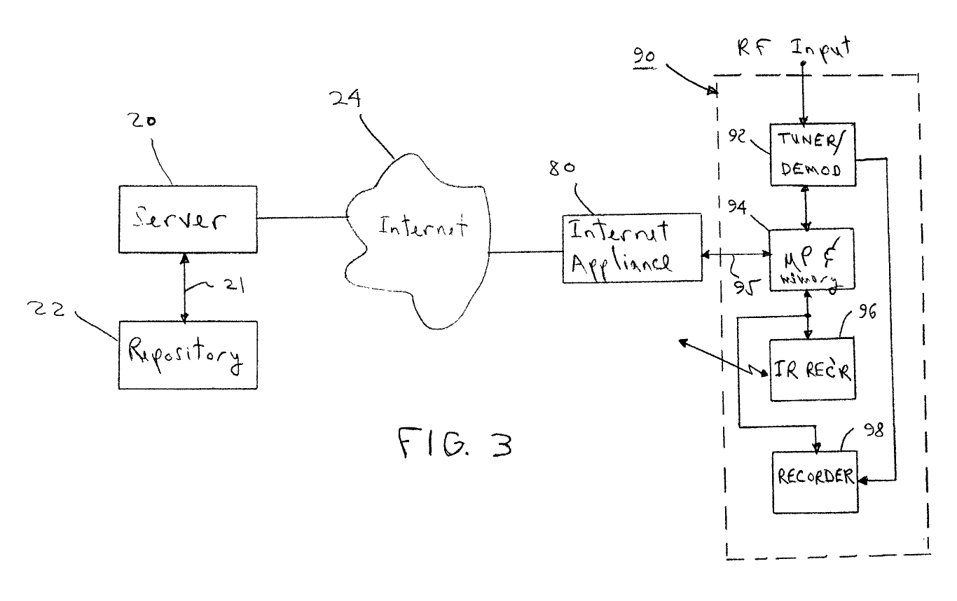

In another embodiment, as shown in FIG. 3, VCR 90 is connected to Internet appliance 80. VCR 90 includes tuner/demodulator 92 which receives a selected broadcast signal (RF input) for conventional recording in recorder 98. VCR 90 also includes processor 94, which may be a special purpose data processor, such as an ASIC, for controlling tuner/demodulator 92 and recorder 98. Processor 94 may be controlled by way of IR receiver 96 or through a digital communications data bus, such as IEEE bus 95.

The embodiment shown in FIG. 3 also includes an option to control VCR 90 by way of an IR generator (not shown), similar to IR generator 68 (shown in FIG. 2). Using IR generator 68 Internet appliance 80 may program VCR 90 without need for a special connection to a digital data bus. With this configuration, any VCR with an IR receiver port may be programmed by way of Internet appliance 80.

Server 20 is adapted to interact with Internet appliance 80. Accordingly, server 20 includes software created for specific Internet appliances, such as appliance 80. Interfacing software (not shown) in server 20 interacts with appliance 80 to set up a connection in certain periodic, pre-programmed or flexible intervals. After completing the connection, server 20 may send VCR programming instructions, as previously discussed, to appliance 80.

Server 20 includes data repository 22, connected by data link 21. Repository 22 may be of the form of optical storage, hard drive storage, or any other storage techniques known for storage and warehousing data. Data stored in repository 22 may include data about participating users, such as addresses, phone numbers, account numbers, log-in and user identifications, and so on. Other data may include information on various Internet appliances, lists of software drivers or applications generic to various appliances, network protocol information, and so on. Virtually any required data may be stored in the form of a database in repository 22, including a start-up screen for interfacing with devices, such as PDA 30, PC 32 or cellular phone 34 (FIG. 1).

Server 20 maintains a constant Internet connection adapted to navigate to and communicate with other known servers, such as vendor servers (referred to as information sites 26 and 28 in FIG. 1). In this manner, server 20 may obtain additional data, as needed, that may not be on-hand. For example, updates of programming schedules from various broadcasting stations may be obtained from these vendors.

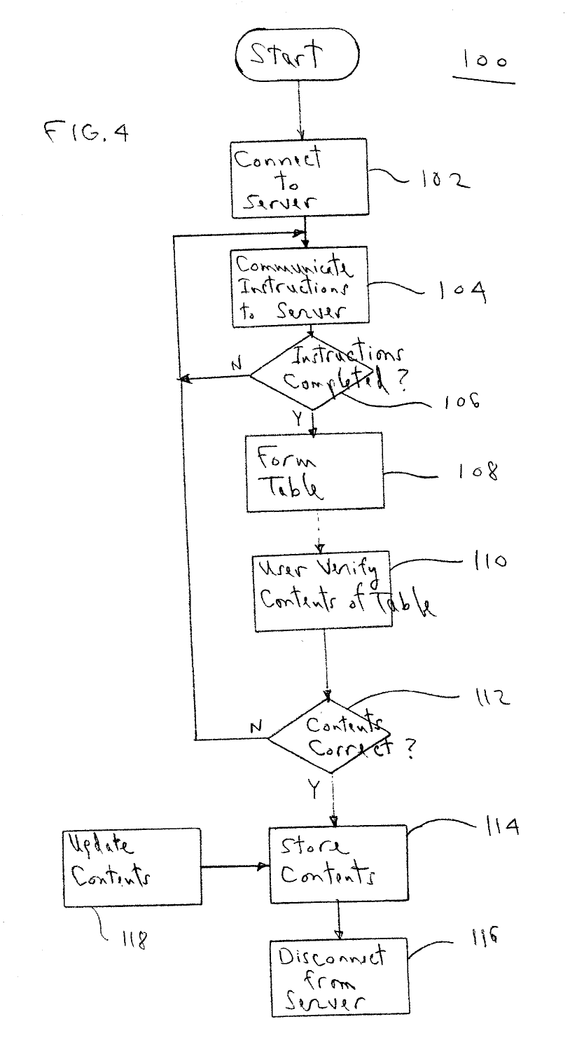

Referring next to FIG. 4, there is shown a basic flow diagram illustrating various steps involved in a typical operation executed via interfacing software according to an embodiment of the present invention. The method, generally designated by the reference numeral 100, is described below.

A user, who may be a subscriber to a service provided by server 20 (FIG. 1), connects to server 20 through the Internet (step 102). The user may be located anywhere and may use any of several devices, such as PDA 30, PC 32 or cellular phone 34 to initiate communications with the server. After proper log-in, the user communicates with the server and provides programming instructions to the server (step 104). In the exemplary embodiment shown in FIGS. 2 and 3, the programming instructions may include instructions to activate VCR 62 (FIG. 2) or VCR 90 (FIG. 3) for recording various programs scheduled to be broadcast during an interval of time.

It will be appreciated that user selection of programs to record may be based on information downloaded from the server and presented as display pages on the user's device. The information may be presented in various formats showing scheduled programming events based on date/time/channel/genre, and so on. The server may download any conventional EPG format.

Alternatively, the user may communicate by voice with server 20 using cellular phone 34. The user may select programs for recording based on perusal of a television guide printed in a newspaper or magazine, or in response to oral prompts from server 20.

Continuing the description of FIG. 4, the method determines whether the user has finished instructing the server on selections of programs to record (step 106). If instructions have not been completed, communications between the server and user continue. If instructions have been completed (as determined, for example, by the user clicking a dialog box on a browser page), the method branches to step 108. The server may then summarize the received instructions by forming a table that lists the selections made by the user (step 108). The server may also download the table to the user for verification (step 110).

The method then determines whether the user has verified the table (step 112). If verification by the user indicates that the table is not correct (as determined, for example, by the user clicking a dialog box on a browser page), the method branches to step 104 and continues communications between the user and server. If verification by the user indicates that the table is correct, however, the method branches to step 114. The table is then stored in server database 22 (step 114), and dialog between the server and user is terminated, thereby ending the on-line connection (step 116).

As part of the service provided to the user, server 20 may obtain EPG information from other sites, and periodically update the program listings stored in the table. The method performs this service in step 118.

The method of the invention also includes server 20 monitoring program listings and program types selected by the user over a period of time. In this manner, viewing habits of the user may be learned by the server. The server may then update the table without user intervention by listing new programs that the user may be interested in viewing. For example, after learning that the user views every show hosted by OPRAH, server 20 may list for recording a new program hosted by OPRAH, scheduled for broadcasting on Tuesday at 9:00 p.m.

In an embodiment of the invention, server 20 may store the programming information selected by the user in a database. Server 20 may also store user preferences and identification of the recording device if Internet-ready, or identification of the Internet-ready appliance connected to the recording device. Server 20 may then, as necessary, download programming instructions to program the recording device. In this manner, server 20 may be keeper of the programming information and a programming proxy for the user. Server 20 may periodically update the programming instructions to the recording device, for example, if a program planned to be broadcast at one scheduled time is changed to be broadcast at a different scheduled time. As another example, the server may periodically refresh the programming instructions to the recording device to preclude loss of programming instructions in the recording device in the event of a power failure. As yet another example, server 20 may download a small portion of the programming instructions stored in the server database, at periodic intervals, in situations where the recording device, for example, cannot store more than one or two programming instructions. As a programming proxy for the user, server 20 may thus tailor downloading of programming instructions based on the capability of the recording device.

In another embodiment, server 20 may maintain a transaction history of recording results and provide a status report to the user of the recording results. The recording results may be provided in response to a request from the user. In this manner, the server may help the user keep track of program recordings. It will be appreciated that a broadcast program may be logged as recorded by the server, after the server has completed instructing the recording device to record the program and the scheduled broadcast of the program has expired. Alternatively, the server may monitor the status of the recording device to confirm that a recording instruction has, in fact, been executed by the recording device.

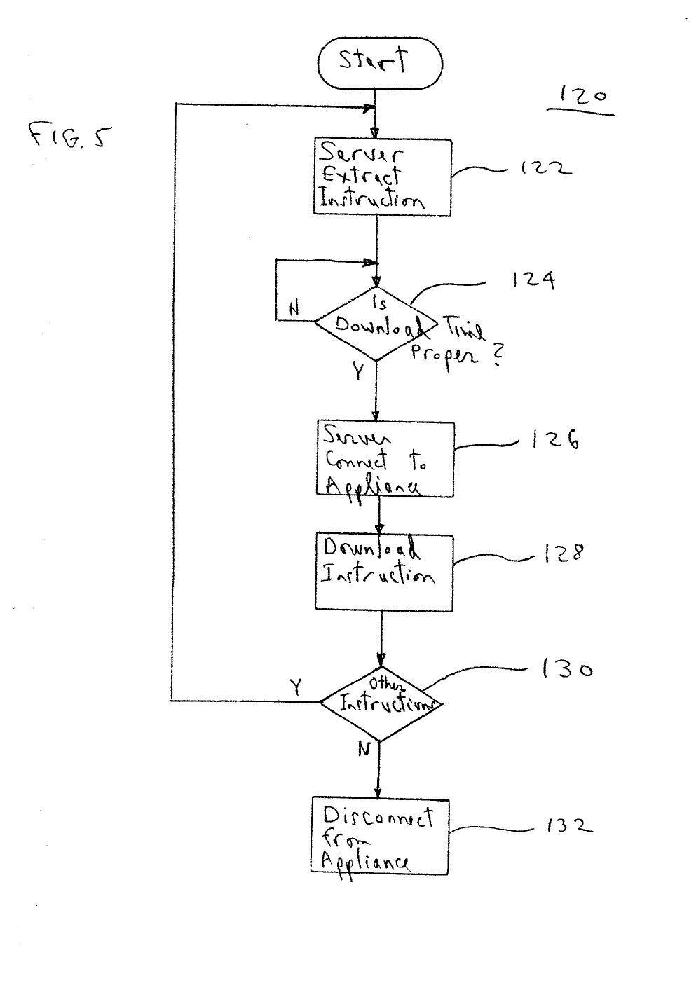

Referring next to FIG. 5, there is shown method 120 illustrating various steps involved in a typical operation executed via interfacing software between server 20 and an Internet-ready appliance, such as appliance 50 (FIG. 2) or appliance 80 (FIG. 3). Prompted by a timer that keeps track of scheduled programming events, server 20 may continually monitor the table stored in database 22. At a predetermined time prior to broadcasting of a specific program listed in the table, server 20 may extract a corresponding instruction to record the program (step 122).

Based on daily traffic variations on the Internet and control delays from appliance 50 to VCR 62 (FIG. 2) or control delays from appliance 80 to VCR 90 (FIG. 3), the server may determine that the extracted instruction of step 122, needs to be downloaded two minutes (for example) prior to broadcast time of the corresponding program. Accordingly, decision box 124 determines whether the correct time has arrived for downloading the instruction. When the correct time arrives, decision box 124 branches to step 126 connecting to the appliance, and downloads the instruction (step 128).

Decision box 130 is entered next. If additional instructions are to be downloaded, the method loops back to step 122. Otherwise, the method branches to step 132 and disconnects the on-line communications between the server and appliance. In one embodiment of the invention, the server downloads a single instruction to the appliance (record program corresponding to a specific “VCR Plus” code) and then disconnects from the appliance. In another embodiment, the server downloads several instructions to the appliance (start time for recording of program and end time for recording of program) and then disconnects from the appliance. In this embodiment, the appliance monitors the correct time and issues commands to the VCR at appropriate times. In yet another embodiment, the server downloads the entire set of instructions listed in the table. The approach selected may depend on the storage capacity of the appliance and VCR.

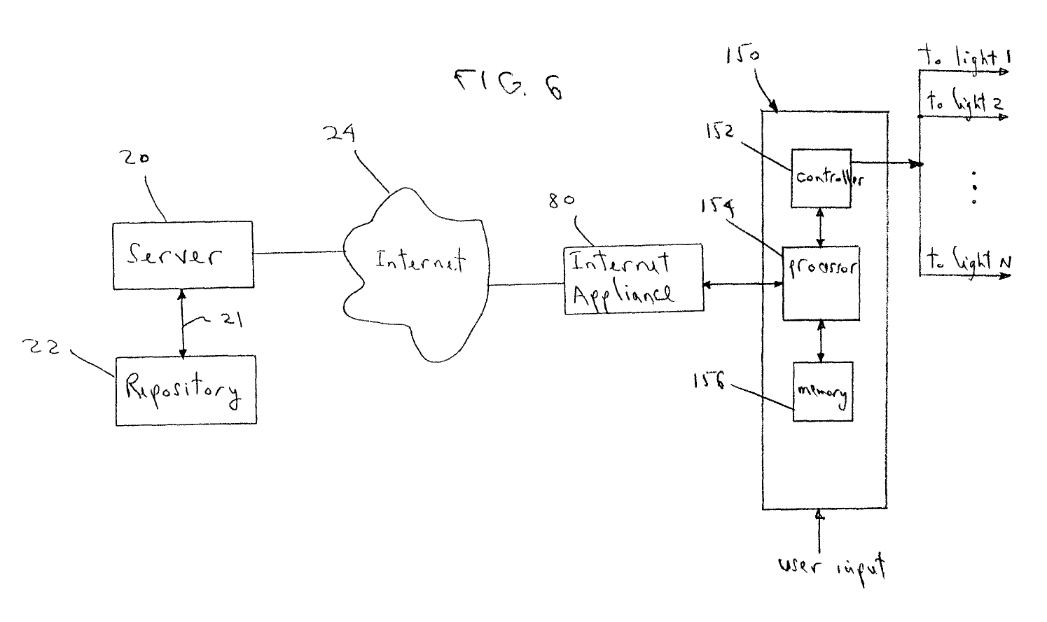

In another embodiment, server 20 may download programming instructions to device 150 by way of Internet 24 and Internet appliance 80, as shown in FIG. 6. As shown, device 150 includes controller 152, processor/CPU 154 and memory 156. Processor 154 includes an operating program for fetching programming instructions from a local user input and a remote server input through the Internet.

As previously described, a user may instruct server 20, through cellular phone 34 (FIG. 1), for example, to download programming instructions for activating or deactivating multiple lights at the user's home. In the exemplary embodiment, device 150 controls activation and deactivation of multiple lights 1-N, located in respective rooms of the user's home. By turning lights on and off at various times, the home appears to be occupied.

It will be appreciated that depending on weather and daylight conditions, it may be desirable to modify a sequence of activating/deactivating lights 1-N as a function of time. Server 20 may thus advantageously modify a sequence stored in memory 156. The sequence may be stored as a table, listing lights 1-N and a respective time for activating or deactivating a light.

Server 20 may connect to Internet appliance 80 and download the sequence for storage in memory 156. Alternatively, server 20 may store the sequence as a table in repository 22. Monitoring the table, server 20, at the appropriate time, may connect to Internet appliance 80 and download a set of instructions to control lights 1-N. At the next appropriate time, server 20 may again connect to Internet appliance 80 and download the next set of instructions. This may be repeated until all the instructions stored in the table have been downloaded.

Server 20 may also monitor the status of device 150. For example, device 150 may sense activation status of the lights (by way of temperature or current sensors; not shown). Lighting status sensed by device 150 may be stored in memory 156. Server 20 may periodically connect to device 150 and request processor 154 to transmit the lighting status stored in memory 156.

Server 20 may also update or upgrade the operating system stored in a read-only-memory (ROM) portion of memory 156. Having previous knowledge of the model and serial number of device 150, server 20 may upgrade the operating system residing in ROM. The manufacturer of device 150 may download the upgraded software to server 20, through the Internet, as shown for example in FIG. 1 (information site 26, 28 communicating with server 20). The upgraded software may also be downloaded to device 150 from server 20 through the Internet.

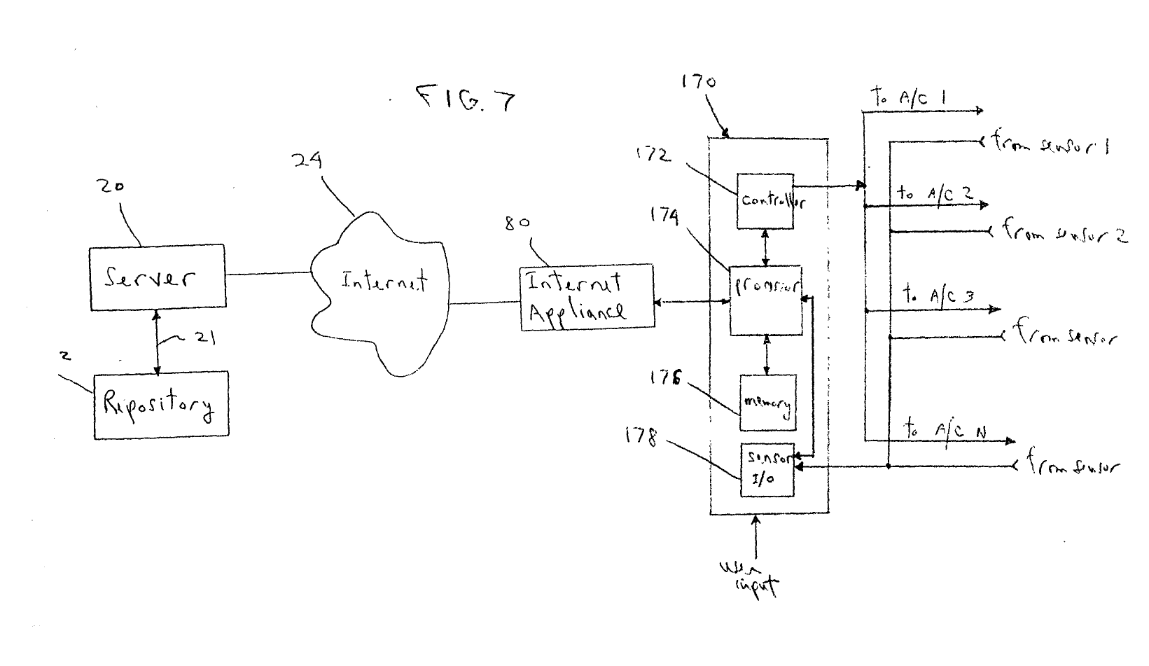

In yet another embodiment, server 20 may download programming instructions to device 170 by way of Internet 24 and Internet appliance 80, as shown in FIG. 7. As shown, device 170 includes controller 172, processor/CPU 174 and memory 176. Controller 172 is coupled to multiple air conditioners 1-N located in various rooms of a user's home. By way of controller 172, processor 174 individually activates and deactivates the air conditioners. Device 170 also includes sensor I/O 178 for interfacing with multiple temperature sensors 1-N, respectively associated with air conditioners 1-N. By monitoring temperature conditions of a room, processor 174 may activate and deactivate an air conditioner in the room. Activation and deactivation settings of each air conditioner may be programmed locally by a user, and stored in a table of memory 176.

Alternatively, the user may instruct server 20 to remotely control air conditioners 1-N. Received instructions from the user may be formatted by the server into a table listing activation and deactivation settings of each air conditioner. The table may be stored in repository 22. After formatting the instructions, server 20 may connect to Internet appliance 80 and download the table for storage in memory 176. Alternatively, server 20 may periodically request Internet appliance 80 to transmit temperature status of sensors 1-N stored in memory 176. In response to the temperature status, server 20 may activate or deactivate specific air conditioners.

Server 20 may monitor the operational status of device 170. When informed of upgraded software by the manufacturer, server 20 may download an upgraded operating system to device 170.

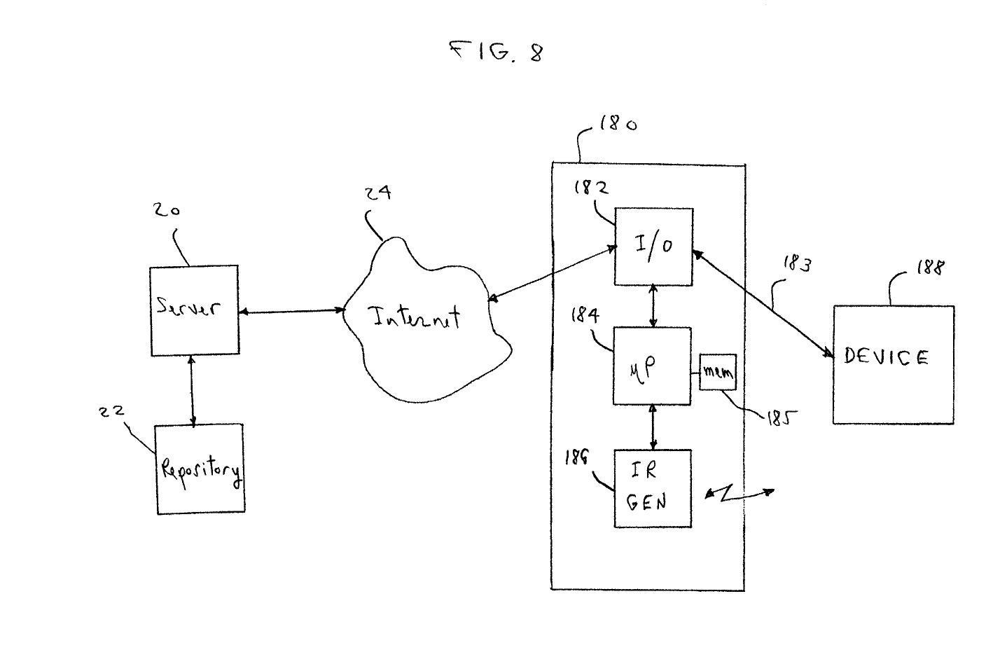

In yet a further embodiment, server 20 may download programming instructions to Internet appliance 180 for controlling device 188, as shown in FIG. 8. Device 188 may be a unit newly purchased by a user. For example, the unit may be a new VCR, such as a VCR 90 (FIG. 3), or a new device for controlling and monitoring conditions of the user's home, such as a device 150 (FIG. 6) and device 170 (FIG. 7).

Newly purchased device 188 may be installed in the user's home by connecting cable 183 between the device and appliance 180. Cable 183 may include a communications bus, such as an IEEE 1394 bus coupled to I/O 182. Alternatively, device 188 may be installed in the same room as appliance 180, so that IR generator 186 may be effective in controlling device 188.

The invention shown in FIG. 8 contemplates that a user may inform server 20 by way of PDA 30, PC 32 or cellular phone 34 (FIG. 1), of the newly installed device 188. Accordingly, the user may identify device 188 by a manufacturer's model and serial number. The user may also instruct server 20 to provide an application program to appliance 180 for controlling and monitoring device 188.

Server 20 may request and obtain, through the Internet, the application program from the manufacturer of device 188, or from information site 26, 28 (FIG. 1). Subsequent to obtaining the application program, server 20 may connect to appliance 180 and download the program to microprocessor 184. The application program may be stored in memory 185.

It will be appreciated that, in other embodiments, the Internet-ready appliance and the device may be integrated into a single unit. For example, the TV and VCR, shown in FIG. 2, may be integrated with appliance 50 in a single unit. As another example, device 90 and appliance 80, shown in FIG. 3, may be integrated in a single unit. Similarly, device 188 and appliance 180, shown in FIG. 8, may be integrated in a single unit.

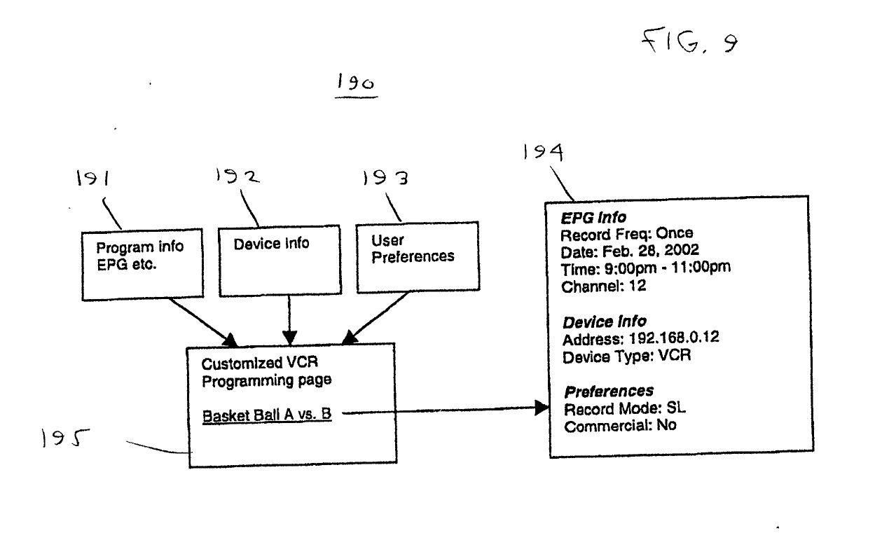

Another embodiment of the invention is shown in FIG. 9. As will be described, one-click programming system 190 may program a recording device with a single command, such as a single click from a user's mouse. System 190 may include a recording device, such as VCR 62 of FIG. 2, recording device 90 of FIG. 3, or device 188 of FIG. 8. System 190 may also include a recording device that is Internet-ready and may be directly connected to Internet 24 of FIG. 1.

One-click programming system 190 may include a customized programming page generated by server 20 (FIG. 3), such as customized VCR programming page 195, shown in FIG. 9. The customized page may be generated by server 20 based on programming information 191, recording device information 192, and user preferences 193 received from a remote user by way of PDA 30, PC 32 or cellular phone 34 (FIG. 1).

Program information 191 may include EPG information available to server 20, by way of database 22 or information sites 26, 28. Device information 192 may include identification of the recording device, such as type of device (VCR for example), manufacturer model and serial number, and an address so that server 20 may remotely program the recording device. User preferences 193 may include, for example, an SL recording mode and a desire to record programs without commercials.

The user may navigate the program information and may select “Basketball A vs. B” by moving a cursor on a display to highlight the desired selection. The user may then click a mouse to command server 20 to program the recording device. Programming information, such as channel number, start and end times, dates and recording frequency may be embedded in a hyperlink that includes, for example, hyperlink information 194, shown in FIG. 9.

Since all programming information is embedded in the hyperlink, the user may advantageously click once on the link (Basketball A vs. B) to program the recording device. The user may send the programming information directly to the recording device, or the server may store the information and send it to the recording device at a later time.

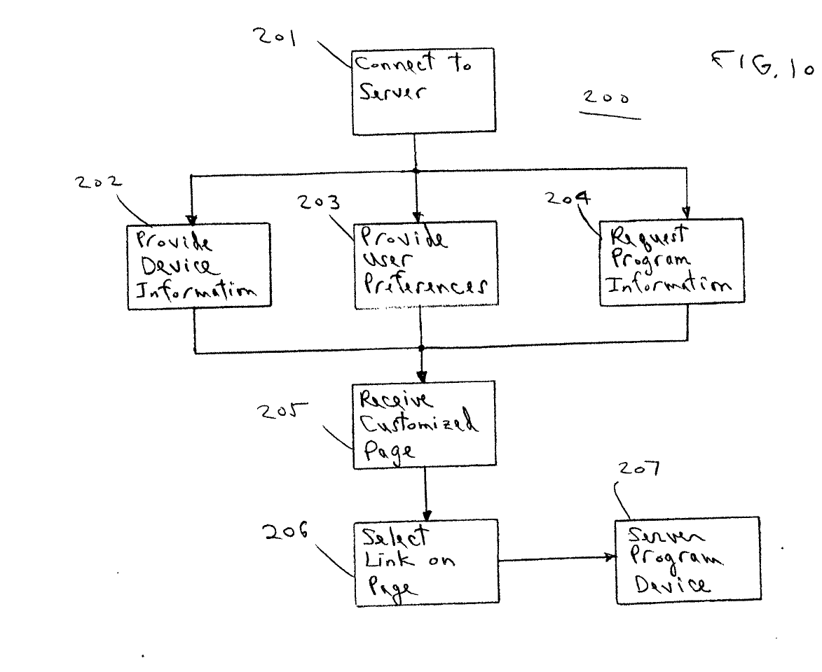

A method of one-click programming, generally designated as 200, is illustrated in FIG. 10. As shown, a user may connect to a server through a browser in step 201 and request EPG program information in step 204. The user may also provide information on the recording device (step 202) and recording preferences (step 203). It will be appreciated that steps 202 and 203 may be performed only once, to permit the server to store the identification of the device and user preferences in a database for generating the customized programming page at a later time.

After receiving a request for EPG program information, the server may generate the customized programming page including hyperlinks and send the page to the user. Upon receiving the customized page in step 205, the user may navigate the page and select a link on the page in step 206. The server may program the recording device in step 207 in response to the link selected by the user.

Although illustrated and described herein with reference to certain specific embodiments, the present invention is nevertheless not intended to be limited to the details shown. Rather, various modifications may be made in the details within the scope and range of equivalents of the claims and without departing from the invention. It will be understood, for example, that the same concept may be extended beyond programming of a device connected to an Internet-ready appliance. For example, any device, including the appliance, connected to a global communications network may be remotely programmed by a server.

Also included within the scope of the invention is the simplification of an Internet-ready appliance by moving data processing and storage, conventionally performed by the appliance, to the server. The server may thus store user configurations, perform computing activities and collect information from the Internet. The server may diagnose, control, and program the appliance. The server may also upgrade software in the appliance, without user interaction.

What is claimed:

1. A method of programming, via a communications network, a recording device to record at least one broadcast program, the method comprising the steps of:
(a) receiving at a server, through the communications network, a request to program the recording device;
(b) customizing at the server a page of programming information including an identification of the one broadcast program, the customizing including
(i) attaching a hyper link to the identified broadcast program, and
(ii) embedding an instruction to the recording device in the hyper link; and
(c) transmitting from the server the customized page of programming information for selection of the identified broadcast program.

2. The method of claim 1 further including the step of:
(d) transmitting from the server to the recording device the embedded instruction after transmitting the customized page in step (c).

3. The method of claim 1 in which step (b) includes embedding recording preferences in the instruction to the recording device.

4. The method of claim 1 in which step (b) includes embedding a start recording instruction and a stop recording instruction of the one broadcast program.

5. The method of claim 1 in which step (b) includes embedding an address of the recording device in the instruction.

6. The method of claim 1 further including the steps of:
(d) transmitting from the server to the recording device the embedded instruction after transmitting the customized page in step (c);
(e) storing the identification of the one broadcast program; and
(f) transmitting from the server the stored identification of the one broadcast program, when requested through the communications network.

7. The method of claim 6 in which said transmitting step (d) is performed at a first time period and said transmitting step (f) is performed at a second time period, wherein the first time period is different from the second time period.

8. The method of claim 1 in which step (a) includes receiving at the server the request using an Internet protocol, and
step (b) includes customizing the page of programming information after identifying the transmitter of the request.

9. The method of claim 1 in which step (b) includes customizing the page of programming information, after receiving data on broadcast programs from an information site remote from the server.

10. A method of programming a video recorder controlled by an appliance comprising the steps of:
(a) receiving at a server, remote from the appliance, through a communications network, a first instruction to record at least one broadcast program in the video recorder; and
(b) transmitting, from the server to the appliance, a second instruction, through the communications network, in response to the first instruction to control the video recorder.

11. The method of claim 10 in which step (a) includes receiving at the server the first instruction transmitted from a location different from the location of the appliance.

12. The method of claim 10 in which step (b) includes transmitting the second instruction through the Internet to the appliance, the appliance being an Internet-ready appliance.

13. The method of claim 10 in which step (a) includes storing the first instruction in a table at the server, the table including a recording time corresponding to the first instruction; and
step (b) includes transmitting the second instruction at a predetermined time prior to the recording time.

14. The method of claim 10 in which step (b) includes controlling the video recorder through the appliance by one of (a) transmitting an IR signal to the video recorder and (b) sending a digital signal via a communications bus to the video recorder.

15. A method of programming, via a communications network, a recording device to record at least one broadcast program, the method comprising the steps of:
(a) requesting, via the communications network, information on broadcast programs;
(b) receiving a customized page of programming information including identification of the one broadcast program;
(c) navigating the customized page of programming information and selecting the one broadcast program; and
(d) programming the recording device via the communications network to record the one broadcast program in response to the selecting in step (c).

16. The method of claim 15 in which step (c) includes highlighting the one identified broadcast program and clicking a mouse, and
step (d) includes sending a programming command to the recording device via the communications network in response to only clicking the mouse.

17. The method of claim 15 further including the steps of:
(e) providing information on the recording device via the communications network, and
(f) providing recording preferences on the recording device via the communications network.

18. The method of claim 17 in which step (c) includes selecting the one broadcast program by selecting a hyper link; and
step (d) includes programming the recording device using at least one of information provided in step (e) and preferences provided in step (f).

19. The method of claim 15 further including the steps of:
(e) requesting a listing of broadcast programs recorded by the recording device; and
(f) receiving the listing of broadcast programs and including in the listing the one broadcast program.

20. A system for programming a video recorder comprising:
a server connected to a network;
a database accessible by the server including electronic program guide (EPG) information;
a video recorder coupled via an appliance to the network; and
a communications device accessible to the network;
wherein the communications device is configured to access the network and to request the server to program the video recorder to record at least one scheduled broadcast program,
the server, in response to the request, is configured to access the database to determine a time corresponding to the scheduled broadcast of the program, and
the server is configured to access the network to download to the appliance programming data for the video recorder.

21. The system of claim 20 wherein the communications device is one of a cellular telephone, personal computer and personal digital assistant.

22. The system of claim 20 wherein the video recorder is coupled to the appliance via one of an IR receiver and a communications bus.

23. The system of claim 20 wherein the database includes a table listing the time corresponding to the scheduled broadcasting of the program, and the server updates the table using electronic program guide (EPG) information.

24. The system of claim 20 wherein the EPG information is stored at information sites accessible by the server via the communications network.
